(19) United States
(12) Patent Application Publication
(10) Pub. No.: US 2005/0106971 A1
(43) Pub. Date: May 19, 2005

(54) Elastomeric laminate with film and strands suitable for a nonwoven garment

(76) Inventor: Oomman Painummoottil Thomas, Alpharetta, GA (US)

Correspondence Address: Melanie I. Rauch;Pauley Petersen & Erickson, Suite 365, 2800 West Higgins Road, Hoffman Estates, IL, 60195, US

(21) Appl. No.: 10/945,353

(22) Filed: Sep. 20, 2004

Related U.S. Application Data
(63) Continuation-in-part of application No. 09/855,194, filed on May 14, 2001, now abandoned.
(60) Provisional application No. 60/204,323, filed on May 15, 2000.

(30) Foreign Application Priority Data
May 15, 2001 (WO) PCT/US01/15580
Nov. 15, 2002 (MX) PA/A/2002/011281
Nov. 14, 2002 (KR) 10/2002/7015292
Dec. 6, 2002 (GB) 0228523.7
Nov. 15, 2002 (DE) 101 96 199.5
Nov. 14, 2002 (BR) 0110860-3

(51) Int. Cl. B32B 25/00; D03D 15/08; D03D 17/00; B32B 25/10

(52) U.S. Cl. 442/181; 442/182; 442/183; 442/293; 442/304; 442/306; 442/305; 442/327; 442/328; 442/366

(57) ABSTRACT

A targeted elastic laminate material includes a plurality of elastomeric strands positioned attached to a first facing layer. A carrier layer having a width narrower than a width of the first facing layer is attached to the first facing layer. At least one of the elastomeric strands is directly attached to the first facing layer adjacent to the carrier layer. At least another of the elastomeric strands may be directly attached to the carrier layer. A second facing layer may also be attached to the first facing layer with at least a portion of the carrier layer positioned between the two facing layers, and at least one elastomeric strand directly attached to both facing layers. Additionally, multiple elastomeric strands may be directly attached to the first facing layer adjacent to opposite longitudinal edges of the carrier layer. A disposable garment may utilize the targeted elastic laminate material to include an area of elasticized gathering under tension to better conform to the body of the wearer. The invention also includes a method of making the targeted elastic laminate material.

### RELATED APPLICATION

This application is a continuation-in-part of U.S. patent application Ser. No. 09/855,194, filed 14 May 2001, which claims priority to U.S. Provisional Patent Application Ser. No. 60/204,323, filed 15 May 2000. The disclosure of the prior applications is incorporated herein by reference.

### BACKGROUND OF THE INVENTION

This invention relates to an elastomeric laminate suitable for use with a garment, such as a nonwoven pant garment, e.g., a diaper or training pants.

Garments, including pant-like absorbent garments, medical garments, and other products, are commonly made with an elastic band adjacent to at least one of the garment openings. A pant-like garment, for instance, may have an elastic band adjacent to the waist opening, each of the two leg openings, or all three of the openings. The elastic bands are intended to fit snugly around a wearer's body to serve as gaskets, which prevent or reduce leakage of waste materials from inside the garment. Elastic bands have also been employed in leg flaps that provide further leakage protection in pant-like garments, and in other auxiliary gasketing applications.

In conventional garments, the primary material for the garment is manufactured and assembled separately from the elastic bands. Following their separate manufacture, the elastic bands are attached to the primary material at some stage during manufacture of the garment by sewing, ultrasonic welding, thermal bonding, adhesive bonding, or the like. In the resulting product, the user can often see the elastic band as a distinct entity attached to the garment.

Because of competition, there is an incentive to reduce both material and manufacturing costs associated with garments, without sacrificing performance and quality. However, this should be accomplished without compromising the gasketing characteristics around the openings in the garment. Conventional elastic bands can be relatively expensive to incorporate into garments, because of the current need for separate manufacture and attachment of the bands.

On the other hand, strands of elastic material integrated into the fabric, and especially nonwoven fabric, in an effort to obviate the separate bands may present problems with delamination of the elastic from the surrounding fabric, especially as the elastic grows in diameter to provide higher tension areas. Problems may also include appearance and performance problems associated with irregularity of placement of the strands during high speed manufacture and additional appearance and performance problems associated with post manufacturing processes such as cutting the integrated-strand fabric which may expose the non-uniform strand placement or cause retraction or slippage of the strands within the nonwoven fabric.

### SUMMARY OF THE INVENTION

The invention is directed to a targeted elastic laminate material suitable for a garment having one or more garment openings for the wearer's waist, legs, arms, and the like. The targeted elastic laminate material suitably has a targeted elastic zone which may be aligned with the garment opening or openings. For example, the targeted elastic laminate material may form at least a portion of the waistband of a garment. The targeted elastic laminate material may have a substantially homogeneous appearance, and does not have a separately manufactured elastic band attached to it. Yet the targeted elastic laminate material may have different elastic properties at different regions, and exhibits greater elastic tension and/or greater elongation in a region aligned with, and in the vicinity of, at least one garment opening. Alternatively, the targeted elastic laminate material may have a an appearance that distinguishes it from the other parts of the garment, such as including a colored film to provide, for example, the appearance of a separate waistband. Compared to materials including separately manufactured elastic bands attached to facing materials with no film layer therebetween, the targeted elastic laminate material provides better adhesion to its surrounding fabric, a more cloth-like look, eliminates elastic strand slippage caused by usage of thicker elastic fibers, provides processing advantages such as eliminating custom extrusion dies, and provides better post processing appearance, such as when cutting to form smaller strips of elastic material. Furthermore, a garment can be produced according to the present invention without the use of a separately manufactured, separately attached elastic band, and is easier and less expensive to manufacture than a conventional garment having one or more elastic bands at the opening.

The targeted elastic material suitably includes a plurality of elastomeric strands attached to a first facing layer, and a carrier layer having a width narrower than a width of the first facing layer. At least one of the elastomeric strands is directly attached to the first facing layer. Additionally, at least another one of the elastomeric strands may be directly attached to the carrier layer. The elastomeric strand(s) directly attached to the carrier layer may either be between the carrier layer and the first facing layer, or attached to the carrier layer on a surface facing away from the first facing layer, or elastomeric strands may be attached to both surfaces of the carrier layer. A second facing layer may be attached to the first facing layer with at least a portion of the carrier layer positioned between the two facing layers, and at least one of the elastomeric strands positioned between and directly attached to the two facing layers. The width of the carrier layer may be narrower than a width of the second facing layer. Alternatively, the width of the carrier layer may be greater than the width of the second facing layer.

The elastomeric strands may differ from one another in one or more ways. For example, some elastomeric strands may exhibit different amounts of elastic tension, or have different cross-sectional dimensions, or have different compositions than one another. Additionally, or alternatively, the carrier layer may include various portions that exhibit different amounts of elastic tension than one another.

In certain embodiments, the targeted elastic laminate material may include at least another elastomeric strand directly attached to the carrier layer. Additionally, or alternatively, the targeted elastic laminate material may include at least two elastomeric strands attached directly to the first facing layer positioned adjacent to opposite longitudinal edges of the carrier layer.

The facing layers may include nonwoven, spunbond, meltblown, woven, film, combinations of any of these or other suitable facing materials. The carrier layer may include an elastomeric film, for example. In certain embodiments, the carrier layer may include the same polymer material as the elastomeric strands. Alternatively, the carrier layer may include a different polymer material than the elastomeric strands. The carrier layer and the elastomeric strands may be substantially the same length. In certain embodiments, the carrier layer and the elastomeric strands may have different lengths, and/or may not be continuous with one another. For example, one or more elastomeric strands may be only partially positioned atop the carrier layer, or only partially attached to the facing layer(s).

The invention also includes a method of producing the targeted elastic laminate material. The method may include simultaneously extruding a plurality of elastomeric strands and a carrier layer onto a facing layer. The elastomeric strands can be in a stretched state when bonded to the carrier layer and/or the facing layer. Alternatively, if both the elastomeric strands and the layer to which the strands are being bonded, namely the carrier layer and/or the facing layer, are elastomeric, the strands need not be stretched when bonding the strands to the elastomeric layer. Some of the elastomeric strands may be extruded onto the carrier layer while other elastomeric strands may be extruded onto a surface of the facing layer adjacent to the carrier layer. A second facing layer may be attached to the first facing layer with the carrier layer and at least some of the elastomeric strands positioned between the first and second facing layers. Additionally, elastomeric strands may be placed onto the surface adjacent to the carrier layer along both longitudinal sides of the carrier layer. The elastomeric strands and the carrier layer are both stretched when the strands are attached to the carrier layer(s).

The carrier layer may be formed by placing an elastomeric polymer extruded from a slotted film die onto a cooling roll and stretching the elastomeric polymer from the cooling roll towards a nip formed between two nip rollers. A tackifier may be added to the formulation of the film to reduce the amount of adhesive spray used in the process. Additionally, or alternatively, the facing layer may be sprayed with an adhesive prior to securing the carrier layer and the filaments to the facing layer.

In certain embodiments, the carrier layer and/or the elastomeric filaments may include a thermoset polymer that is cross-linked prior to securing the filaments to the carrier layer. In certain other embodiments, the carrier layer and/or the elastomeric filaments can be cross-linked after securing the filaments to the carrier layer. Additionally, LYCRA® spandex, which is a solution-spun polymer that cannot be thermally processed, may be included in the formation of the carrier layer and/or the elastomeric filaments.

With the foregoing in mind, it is a feature and advantage of the invention to provide an elastomeric material for use with a garment having a targeted elastic region aligned with, and in the vicinity of at least one garment opening, while eliminating the separate manufacture and attachment of an elastic band.

It is also a feature and advantage of the invention to provide various techniques for providing an elastic material which may have its elasticity, namely elongation and tension, varied by manipulation of its individual components' basis weight or physical structure.

These and other features and advantages will become further apparent from the following detailed description of the presently preferred embodiments, read in conjunction with the drawings.

### BRIEF DESCRIPTION OF THE DRAWINGS

FIG. 1 illustrates a perspective view of a pant-like absorbent garment in accordance with the invention, having targeted elastic gasket regions aligned with, and in the vicinity of garment openings.

FIG. 2 is a plan view of the garment shown in FIG. 1, showing the side facing away from the wearer.

FIG. 3 is a plan view of the garment shown in FIG. 1, showing the side facing the wearer.

FIGS. 4-8, 9A-9E, 10A-10D, and 11A-11C illustrate representative examples of the targeted elastic laminate materials of the invention.

FIG. 12 is a top view of one example of the targeted elastic laminate material .

FIG. 13 is a top view of another example of the targeted elastic laminate material.

FIG. 14 illustrates a representative process for making the targeted elastic laminate materials useful for making garments in accordance with the invention.

FIG. 15 is a schematic view of another process for making the targeted elastic laminate materials useful for making garments in accordance with the invention.

FIG. 16 illustrates a side view of an extruder die in relation to a first roller, as may be used with the apparatus of FIG. 14.

FIG. 17A shows one exemplary adhesive spray pattern in which the adhesive has been applied to the elastic filaments with attenuation in the cross direction.

FIG. 17B shows a second exemplary adhesive spray pattern.

FIG. 17C illustrates a third exemplary adhesive spray pattern.

FIG. 17D shows an exemplary bond angle in one exemplary adhesive spray pattern.

FIG. 18 illustrates the bonding pattern and method of calculating the number of bonds per unit length on elastic strands or filaments.

FIG. 19A shows a fourth exemplary adhesive spray pattern in a swirled-type of configuration.

FIG. 19B shows a fifth exemplary adhesive spray pattern that is more randomized and which provides a large percentage of adhesive lines in a perpendicular orientation to the elastic filaments.

FIG. 19C illustrates a sixth exemplary adhesive spray pattern having attenuation of adhesive lines in the cross-machine direction.

FIG. 19D shows a seventh exemplary adhesive spray pattern that resembles a “chain-link fence.”

FIG. 20 illustrates stress relaxation behavior of targeted elastic and non-targeted-elastic materials at body temperature.

FIG. 21 illustrates hysteresis behavior of targeted elastic and non-targeted-elastic materials.

FIG. 22 illustrates stretch-to-stop behavior of targeted elastic and non-targeted-elastic materials.

### DEFINITIONS

Within the context of this specification, each term or phrase below will include the following meaning or meanings.

The terms “elastic” and “elastomeric” are used interchangeably to mean a material that is generally capable of recovering its shape after deformation when the deforming force is removed. Specifically, as used herein, elastic or elastomeric is meant to be that property of any material which upon application of a biasing force, permits that material to be stretchable to a stretched biased length which is at least about 50 percent greater than its relaxed unbiased length, and that will cause the material to recover at least 40 percent of its elongation upon release of the stretching force. A hypothetical example which would satisfy this definition of an elastomeric material would be a one (1) inch sample of a material which is elongatable to at least 1.50 inches and which, upon being elongated to 1.50 inches and released, will recover to a length of less than 1.30 inches. Many elastic materials may be stretched by much more than 50 percent of their relaxed length, and many of these will recover to substantially their original relaxed length upon release of the stretching force.

The term “inelastic” refers to materials that are not elastic.

The term “gasket” or “gasket region” refers to a region of a garment which exhibits a moderate level of elastic tension against a wearer's body during use, and which restricts the flow of liquid and other material through a garment opening between the inside and outside of the garment. The term “fluid sealing gasket” is synonymous with these terms.

The term “targeted elastic laminate material” refers to a single elastic material or laminate having targeted elastic regions. Targeted elastic laminate materials include only materials or laminates that are made in a single manufacturing process, and that are capable of exhibiting targeted elastic properties without requiring an added elastic band or layer in the targeted elastic region. Targeted elastic laminate materials do not include materials having elasticized regions achieved through separate manufacture of an elastic band, and subsequent connection of the elastic band to the underlying material.

The term “targeted elastic regions” refers to isolated, often relatively narrow regions or zones in a single composite material or layer, which have greater elastic tension and/or elongation than adjacent or surrounding regions.

The term “vertical filament stretch-bonded laminate” or “VF SBL” refers to a stretch-bonded laminate made using a continuous vertical filament process, as described herein.

The term “elastic tension” refers to the amount of force per unit cross-sectional area required to stretch an elastic material (or a selected zone thereof) to a given percent elongation. For example, the cross-sectional area of an elastic strand is taken across a section of the strand, which can be calculated from a knowledge of the radius of the filament or in the case of a ribbon-shaped material by knowing the width and thickness of the ribbon, rather than along the longitudinal length of the strand.

The term “elongation” refers to the capability of an elastic material to be stretched a certain distance, such that greater elongation refers to an elastic material capable of being stretched a greater distance than an elastic material having lower elongation.

The term “low tension zone” or “lower tension zone” refers to a zone or region in a stretch-bonded laminate material having one or more filaments with low elastic tension characteristics relative to the filament(s) of a high tension zone, when a stretching or biasing force is applied to the stretch-bonded laminate material. Thus, when a biasing force is applied to the material, the low tension zone will stretch more easily than the high tension zone. At 50% elongation of the fabric, the high tension zone may exhibit elastic tension at least 10% greater, suitably at least 50% greater, desirably about 100-800% greater, alternatively about 150-300% greater than the low tension zone.

The term “high tension zone” or “higher tension zone” refers to a zone or region in a stretch-bonded laminate material having one or more filaments with high elastic tension characteristics relative to the filament(s) of a low tension zone, when a stretching or biasing force is applied to the stretch-bonded laminate material. Thus, when a biasing force is applied to the material, the high tension zone will stretch less easily than the low tension zone. The terms “high tension zone” and “low tension zone” are relative, and the material may have multiple zones of different tensions.

The term “nonwoven fabric or web” means a web having a structure of individual fibers or filaments which are interlaid, but not in an identifiable manner as in a knitted fabric. The terms “fiber” and “filament” are used herein interchangeably. Nonwoven fabrics or webs have been formed from many processes such as, for example, meltblowing processes, spunbonding processes, air laying processes, and bonded carded web processes. The basis weight of nonwoven fabrics is usually expressed in ounces of material per square yard (osy) or grams per square meter (gsm) and the fiber diameters are usually expressed in microns. (Note that to convert from osy to gsm, multiply osy by 33.91.)

As used herein, the term “spunbond fibers” refers to small diameter fibers which are formed by extruding molten thermoplastic material as filaments from a plurality of fine, usually circular capillaries of a spinneret as taught, for example, by U.S. Pat. No. 4,340,563 to Appel et al. and U.S. Pat. No. 3,802,817 to Matsuki et al.

As used herein, the term “meltblown fibers” refers to fibers formed by extruding a molten thermoplastic material through a plurality of fine, usually circular, die capillaries as molten threads or filaments into converging high velocity gas streams (for example, airstreams) which attenuate the filaments of molten thermoplastic material to reduce their diameter, which may be to microfiber diameter. Such a process is disclosed, for example, by U.S. Pat. No. 3,849,241 to Butin.

As used herein, the term “microfibers” refers to small diameter fibers having an average diameter not greater than about 75 microns, for example, having an average diameter of from about 0.5 microns to about 50 microns, or more particularly, having an average diameter of from about 2 microns to about 40 microns.

The term “polymer” generally includes but is not limited to, homopolymers, copolymers, including block, graft, random and alternating copolymers, terpolymers, etc., and blends and modifications thereof. Furthermore, unless otherwise specifically limited, the term “polymer” shall include all possible geometrical configurations of the material. These configurations include, but are not limited to isotactic, syndiotactic and atactic symmetries.

The term “substantially continuous filaments or fibers” refers to filaments or fibers prepared by extrusion from a spinnerette, including without limitation spunbonded and meltblown fibers, which are not cut from their original length prior to being formed into a nonwoven web or fabric. Substantially continuous filaments or fibers may have lengths ranging from greater than about 15 cm to more than one meter; and up to the length of the nonwoven web or fabric being formed. The definition of “substantially continuous filaments or fibers” includes those which are not cut prior to being formed into a nonwoven web or fabric, but which are later cut when the nonwoven web or fabric is cut.

The term “recover” or “retract” relates to a contraction of a stretched material upon termination of a biasing force following stretching of the material by application of the biasing force.

The term “stretch to stop” or “STS” indicates the percentage of elongation of an elastic material when placed under a tensile load of 2000 grams.

The term “garment” includes personal care garments, medical garments, and the like. The term “disposable garment” includes garments which are typically disposed of after 1-5 uses. The term “personal care garment” includes diapers, training pants, swim wear, absorbent underpants, adult incontinence products, feminine hygiene products, and the like. The term “medical garment” includes medical (i.e., protective and/or surgical) gowns, caps, gloves, drapes, face masks, and the like. The term “industrial workwear garment” includes laboratory coats, cover-alls, and the like.

“Inward” and “outward” refer to positions relative to the center of an article, and particularly transversely and/or longitudinally closer to or away from the longitudinal and transverse center of the article, and are analogous to proximal and distal.

The term “film” refers to an article of manufacture whose width exceeds its thickness and provides the requisite functional advantages and structure necessary to accomplish the claimed invention.

The term “strand” refers to an article of manufacture whose diameter is less than the width of a film and is suitable for securement to a film according to the present invention.

The term “series” refers to a set including one or more elements.

The term “attached” refers to the joining, adhering, connecting, bonding, or the like, of two elements. Two elements will be considered to be attached together when they are attached directly to one another or indirectly to one another, such as when each is directly bonded to intermediate elements.

The term “directly attached” refers to the joining, adhering, connecting, bonding, or the like, of two elements wherein the two elements are in direct contact with one another along at least a portion of the attached area. Bonding materials themselves, such as adhesives, are not considered to be “intermediate elements,” but are merely devices used to facilitate the direct attachment of two elements.

The term “adjacent” refers to the orientation of one element with respect to another element, wherein the elements are positioned next to one another but are not directly attached to one another.

The term “thermoplastic” describes a material that softens when exposed to heat and which substantially returns to a nonsoftened condition when cooled to room temperature.

The term “thermoset” describes a material that is capable of becoming chemically or structurally altered, such as becoming permanently cross-linked, and cannot be further thermally processed following such alteration.

With respect to the term “cross-link,” while linear molecules are important, they are not the only type of polymer molecules possible. Branched and cross-linked polymer molecules also play an important role in the structure and properties of polymers. When additional polymer chains emerge from the backbone of a linear polymer chain, it is said to be branched. Branching is introduced intentionally by adding monomers with the capability to act as a branch. The amount of branching introduced must be specified to characterize a polymer molecule completely. The branching points are referred to as junction points. When the concentration of the junction points is low, the molecules may be characterized by the number of chain ends. For example, two linear molecules have four chain ends. If one of this linear molecule is attached to the middle of the other linear molecule the resulting structure looks like a “T”. The total number of chain ends of this “T” molecule is three. Addition of another “T” to the end of another “T” will result in four chain ends. This process can be continued until a critical concentration of the resulting junction points is reached. Further coupling of the chain ends leads to a transition that transforms a solvent soluble, and a thermally processable branched polymer to an infusible and insoluble polymer mass. The number of junction points in such a mass becomes so high that the polymer molecule is theoretically considered to be one giant molecule that has a three-dimensional network structure. When this condition is achieved it is said to be cross-linked. Polymer molecules can be cross-linked in several ways, by changing the chemistry or by irradiating it with high energy beams such as UV, gamma ray, e-beam, etc. Some examples of chemical cross-linking are: 1) natural rubber, cis-1,4-polyisoprene, cross-linked with sulfur. This was discovered by Goodyear in 1839. This reaction process is also known as vulcanization; 2) vinyl polymers cross-linked with divinyl monomers, for example polystyrene polymerized in the presence of divinyl benzene, 3) condensation polymers prepared from monomer of functionality greater than two, for example polyester formed with some glycerol or tricarboxylic acid, and 4) polysilicones cross-linked by reaction of benzoyl peroxide. An example of cross-linking by high-energy electron beam is the cross-linking of polyethylene by radiation.

These terms may be defined with additional language in the remaining portions of the specification.

### DESCRIPTION OF PREFERRED EMBODIMENTS

The principles of this invention can be applied to a wide variety of garments, including disposable garments, having a targeted elastic zone in the vicinity of at least one garment opening. Examples include diapers, training pants, certain feminine hygiene products, adult incontinence products, other personal care or medical garments, and the like. For ease of explanation, the following description is in terms of a refastenable child training pant having targeted elastic laminate material used for containment flaps and a waist dam.

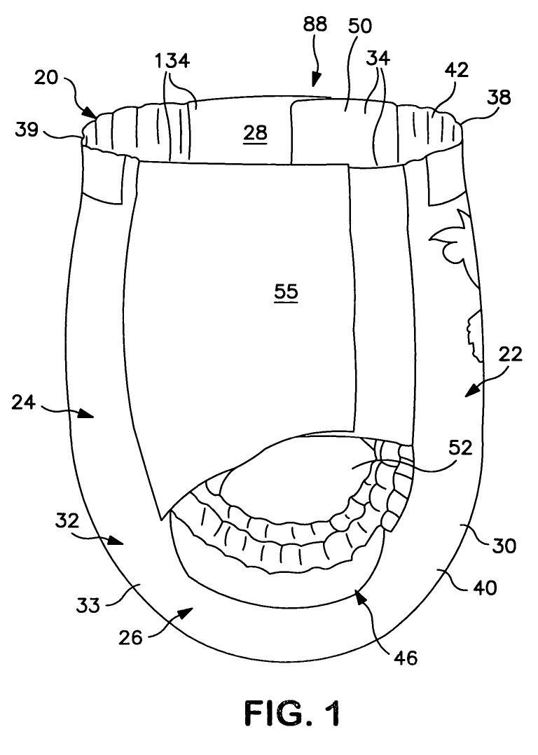

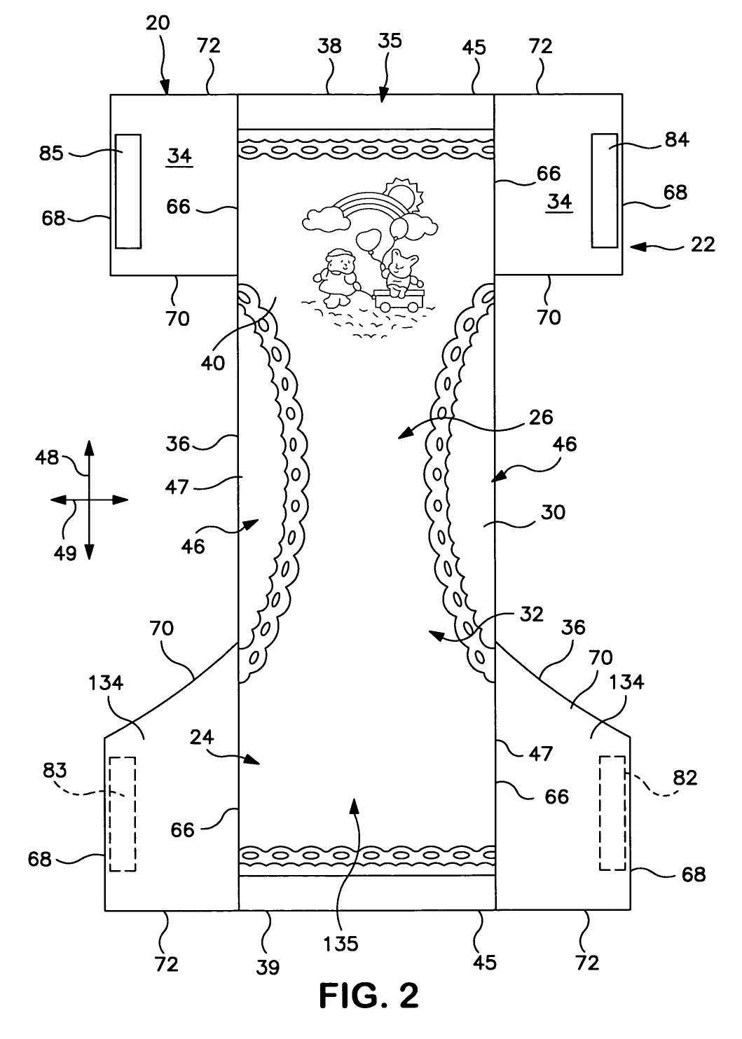

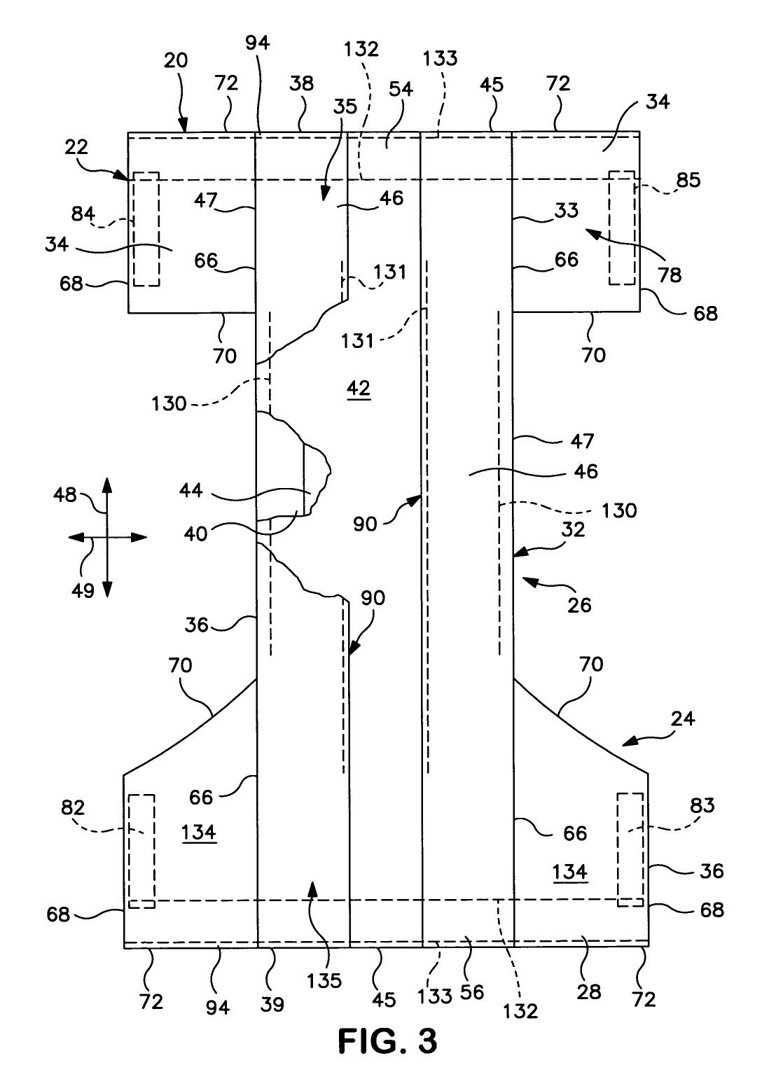

Referring to FIG. 1, a disposable absorbent garment 20, such as a child training pant, includes an absorbent chassis 32 and a fastening system 88. The absorbent chassis 32 defines a front waist region 22, a back waist region 24, a crotch region 26 interconnecting the front and back waist regions, an inner surface 28 which is configured to contact the wearer, and an outer surface 30 opposite the inner surface which is configured to contact the wearer's clothing. With additional reference to FIGS. 2 and 3, the absorbent chassis 32 also defines a pair of transversely opposed side edges 36 and a pair of longitudinally opposed waist edges, which are designated front waist edge 38 and back waist edge 39. The front waist region 22 is contiguous with the front waist edge 38, and the back waist region 24 is contiguous with the back waist edge 39. The chassis 32 defines waist opening 50 and two opposing leg openings 52.

The illustrated absorbent chassis 32 comprises a rectangular absorbent composite structure 33, a pair of transversely opposed front side panels 34, and a pair of transversely opposed back side panels 134. The composite structure 33 and side panels 34 and 134 may be integrally formed or comprise two or more separate elements, as shown in FIG. 1. The illustrated composite structure 33 comprises an outer cover 40, a bodyside liner 42 (FIGS. 1 and 3) which is connected to the outer cover in a superposed relation, an absorbent assembly 44 (FIG. 3) which is located between the outer cover and the bodyside liner, and a pair of containment flaps 46 (FIG. 3). The rectangular composite structure 33 has opposite linear end edges 45 that form portions of the front and back waist edges 38 and 39, and opposite linear side edges 47 that form portions of the side edges 36 of the absorbent chassis 32 (FIGS. 2 and 3). For reference, arrows 48 and 49 depicting the orientation of the longitudinal axis and the transverse axis, respectively, of the training pant 20 are illustrated in FIGS. 2 and 3.

The front waist region 22 of the absorbent chassis 32 includes the transversely opposed front side panels 34 and a front center panel 35 (FIGS. 2 and 3) positioned between and interconnecting the side panels. The back waist region 24 of the absorbent chassis 32 includes the transversely opposed back side panels 134 and a back center panel 135 (FIGS. 2 and 3) positioned between and interconnecting the side panels. The waist edges 38 and 39 of the absorbent chassis 32 are configured to encircle the waist of the wearer when worn and provide the waist opening 50 which defines a waist perimeter dimension. Portions of the transversely opposed side edges 36 in the crotch region 26 generally define the leg openings 52.

In the embodiment shown in FIG. 1, the front and back side panels 34 and 134 are fastened together by fastening system 88 to form collective side panels 55 (with each collective side panel 55 including a front side panel 34 and back side panel 134). The fastening system 88 may include a plurality of fastener tabs 82, 83, 84 and 85, which can be known hook-and-loop fastener members. It will be appreciated that any number of side panel configurations may be utilized in the context of the present invention.

The illustrated side panels 34 and 134, in FIGS. 2 and 3, each define a distal edge 68 that is spaced from the attachment line 66, a leg end edge 70 disposed toward the longitudinal center of the training pant 20, and a waist end edge 72 disposed toward a longitudinal end of the training pant. The leg end edge 70 and waist end edge 72 extend from the side edges 47 of the composite structure 33 to the distal edges 68. The leg end edges 70 of the side panels 34 and 134 form part of the side edges 36 of the absorbent chassis 32. In the back waist region 24, the leg end edges 70 are desirably although not necessarily angled relative to the transverse axis 49 to provide greater coverage toward the back of the pant as compared to the front of the pant. The waist end edges 72 are desirably parallel to the transverse axis 49. The waist end edges 72 of the front side panels 34 form part of the front waist edge 38 of the absorbent chassis 32, and the waist end edges 72 of the back side panels 134 form part of the back waist edge 39 of the absorbent chassis.

Referring to FIGS. 1-3, in accordance with the invention, the containment flaps 46, desirably continuous with the chassis 32, each include a targeted elastic laminate material including at least one elasticized, low tension and/or high stretch zone 130 in the vicinity of (and aligned with) leg openings 52, and at least one narrow, band-like high tension and/or low stretch zone 131 in the vicinity of (and aligned with) the unattached, gasket-like edges 90 of the containment flaps 46 thereby creating a gasket at the gasket-like edges 90 of the containment flaps 46 (FIG. 3). The containment flaps 46 can be separate, attached pieces (as shown in FIGS. 1 and 2), or can be an extension of the outer cover 40, as shown in FIG. 3. The dotted lines in FIG. 3 indicate the boundaries between the low tension and/or high stretch zone 130 and the high tension and/or low stretch zone 131, which boundaries are not visible to an observer. The low tension and/or high stretch zone 130 and the high tension and/or low stretch zone 131 are suitably spaced apart, as shown in FIG. 3. From the standpoint of the observer, the targeted elastic laminate material forming the containment flaps 46 appears as a homogeneous, integrated material. Alternatively, the targeted elastic laminate material may have the appearance of separate components, such as through the use of colored film to provide, for example, the appearance of a separate waistband.

The high tension and/or low stretch zone 131 exhibits greater elastic tension and/or elongation than the low tension and/or high stretch zone 130 of the containment flaps 46, without requiring the use of separately manufactured and attached elastic materials. Unlike separately manufactured and attached elastic materials, the targeted elastic laminate materials include a film or carrier layer, which creates a distributed load compared to a concentrated load created by elastic strand materials. More particularly, the carrier layer distributes the elastic tension and provides a wide margin for cutting, whereas separately attached elastic materials have tension concentrated at the locations of the elastic materials and the elastic materials are likely to hang loose when cut. Furthermore, desired spacing between the high tension and/or low stretch zone 131 and the low tension and/or high stretch zone 130 allows the zones 131 and 130 to stretch independently of one another so as not to constrain elongation capacity of either zone 131 and 130.

To further enhance containment and/or absorption of body exudates, the training pant 20 desirably includes a waist dam having a front waist dam portion 54 and a rear waist dam portion 56 (FIG. 3) of a high tension and/or low stretch zone 133 in the vicinity of (and aligned with) the waist edges 38 and 39. The waist dam portions 54 and 56 can be separate, attached pieces, or can be extensions of the outer cover 40, as shown in FIG. 3. From the standpoint of the observer, the targeted elastic laminate material forming the waist dam portions 54 and 56 appears as a homogeneous, integrated material.

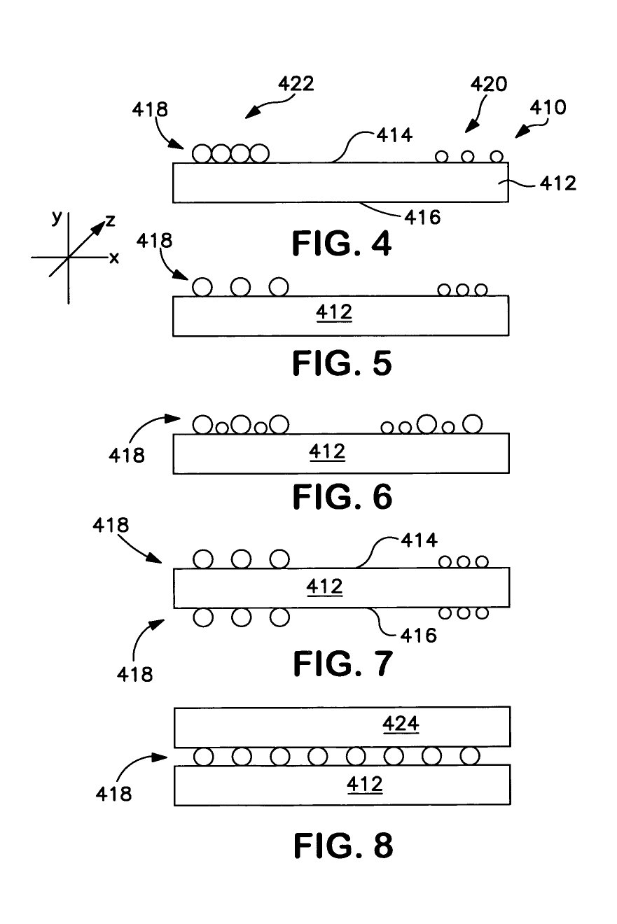

The containment flaps 46 and the waist dam portions 54 and 56 are manufactured from a targeted elastic laminate material. In certain embodiments, a waistband may be manufactured from a targeted elastic laminate material. The entirety or only a portion of the waist opening 50 may be formed from a targeted elastic laminate material. More particularly, a front waistband may be positioned along the front waist edge 38 and/or a back waistband may be positioned along the back waist edge 39. Various embodiments of targeted elastic laminate materials are shown in FIGS. 4-13.

As seen in FIG. 4, an elastomeric laminate 410 comprises a carrier layer 412, such as an elastomeric film, having a first major surface 414 and a second major surface 416. Secured to the first major surface 414 are strands 418 of elastomeric material. The longitudinal axes of the film 412 and the strands, collectively 418, run in the same direction, which in FIGS. 4-12 is the indicated Z direction going into the illustration. The elastomeric strands 418 are suitably but not necessarily secured to the film 412 by a combination of tackifiers within the elastomeric compositions and an application of melt sprayed adhesive on the film's major surface. The right side 420 and left side 422 of the film 412 may have differential spacing among their respectively grouped strands, which can impart a different level of tension between the two areas. It will be appreciated that the strands may be laid out periodically, non-periodically, and in various spacings, groupings, sizes, and compositions of elastic material according to the effect desired from the elastic laminate and the use to which it is put. For example, FIG. 5 illustrates unequal sized elastomeric strands 418 with the left side grouping being of larger diameter and thus of higher tension than the smaller diameter right side grouping. While referred to as being of different diameter, it will be appreciated that the elastomeric strands 418 need not be circular in cross-section within the context of the present invention. FIG. 6 illustrates that the strands of different size may be intermingled within groupings in regular or irregular patterns. FIG. 7 illustrates that various strands 418 may be secured to both of the first and second major surfaces 414, 416 respectively, of the film 412. FIG. 8 illustrates that the laminate of the film 412 and strands 418 may have an additional film 424 secured to the strands 418 thereby sandwiching the strands 418 between the first, or original, film 412 and the second film 424. All of the above techniques as well as the basis weight and physical structure, e.g. strand-like, film-like or meltblown structures may be utilized, in conjunction with the chemical compositions of the laminate elements to vary the elastic tension of the laminate as a whole. Also, the tension of different portions of the film 412 can be varied from one another, and in addition, the tension among the strands 418 can vary from one another as well. Furthermore, rather than a film 412, a sheet of netting or nonwoven may instead be used as the carrier layer for attaching the strands 418.

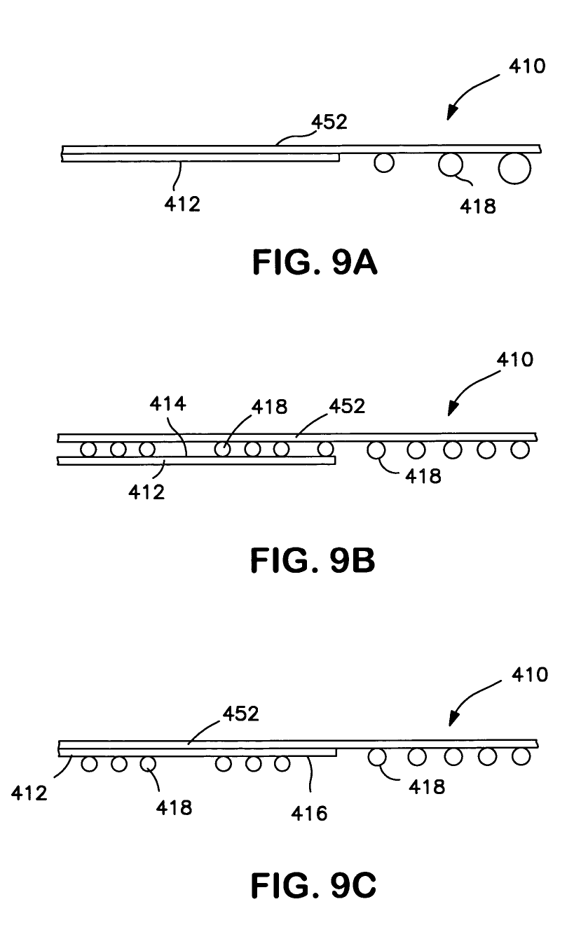

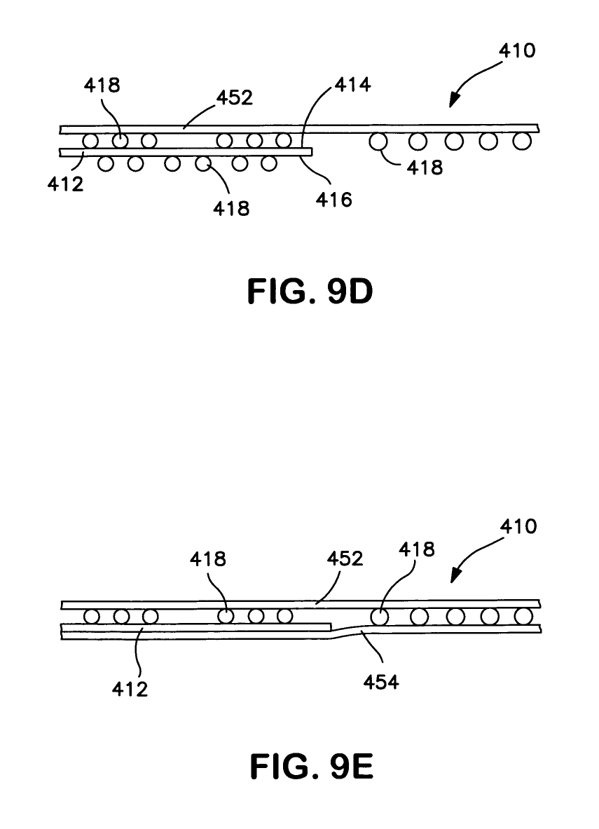

As shown in FIGS. 9A, 9B, 9C, and 9D, another targeted elastic laminate material 410 may include a plurality of elastomeric strands 418 attached to a first facing layer 452, and a carrier layer 412 having a width (in the x-direction) narrower than a width of the first facing layer 452. As shown in FIG. 9A, the elastomeric strands 418 may be attached to the first facing layer 452 adjacent to the carrier layer 412. Alternatively, as shown in FIGS. 9B, 9C, and 9D, at least one of the elastomeric strands 418 may be directly attached to the carrier layer 412, and at least another one of the elastomeric strands 418 may be directly attached to the first facing layer 452 without being directly attached to the carrier layer 412. The elastomeric strand(s) 418 directly attached to the carrier layer may either be on a surface 414 of the carrier layer 412 facing the first facing layer 452 as shown in FIG. 9B, or attached to the carrier layer 412 on a surface 416 facing away from the first facing layer 452 as shown in FIG. 9C, or elastomeric strands 418 may be attached to both surfaces 414, 416 of the carrier layer 412 as shown in FIG. 9D.

FIG. 9E illustrates another embodiment in which a second facing layer 454 may be attached to the first facing layer 452 with at least a portion of the carrier layer 412 positioned between the two facing layers 452, 454, and at least one of the elastomeric strands 418 positioned between and directly attached to the two facing layers 452, 454. The width of the carrier layer 412 may be narrower than a width of the second facing layer 454. Alternatively, the width of the carrier layer 412 may be narrower than a width of the second facing layer 454. Because the carrier layer 412 is narrower than one or both facing layers, at least one of the elastomeric strands 418 is positioned adjacent to the carrier layer 412, and is therefore directly attached to both the first and second facing layers 452, 454.

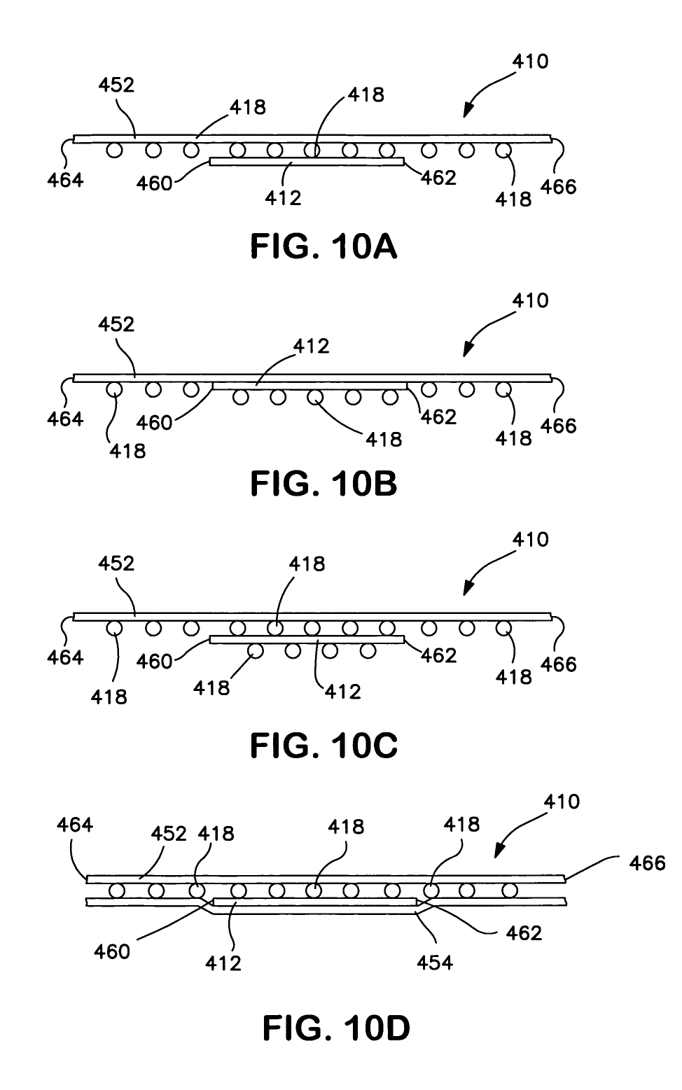

FIGS. 10A, 10B, and 10C illustrate a targeted elastic laminate material 410 having elastomeric strands 418 positioned adjacent to opposite longitudinal sides 460, 462 of the carrier layer 412. More particularly, the width of the carrier layer 412 is defined by a first longitudinal edge 460 and a second longitudinal edge 462. Similarly, the widths of the first and second facing layers 452, 454 are also defined by a first longitudinal edge 464 and a second longitudinal edge 466. At least one elastomeric strand 418 is directly attached to the carrier layer 412 At least another elastomeric strand 418 is directly attached to the first and facing layer 452 adjacent to the carrier layer 412, namely between the first longitudinal edge 464 of the first facing layer 452 and the first longitudinal edge 460 of the carrier layer 412. At least another elastomeric strand 418 is directly attached to the first facing layer 452 adjacent to the opposite side of the carrier layer 412, namely between the second longitudinal edge 466 of the first facing layer 452 and the second longitudinal edge 462 of the carrier layer 412. As shown in FIG. 10D, a second facing layer 454 can be attached to the first facing layer 452 with at least a portion of the carrier layer 412 positioned between the two facing layers 452, 454, and at least two of the elastomeric strands 418 positioned between and directly attached to the two facing layers 452, 454.

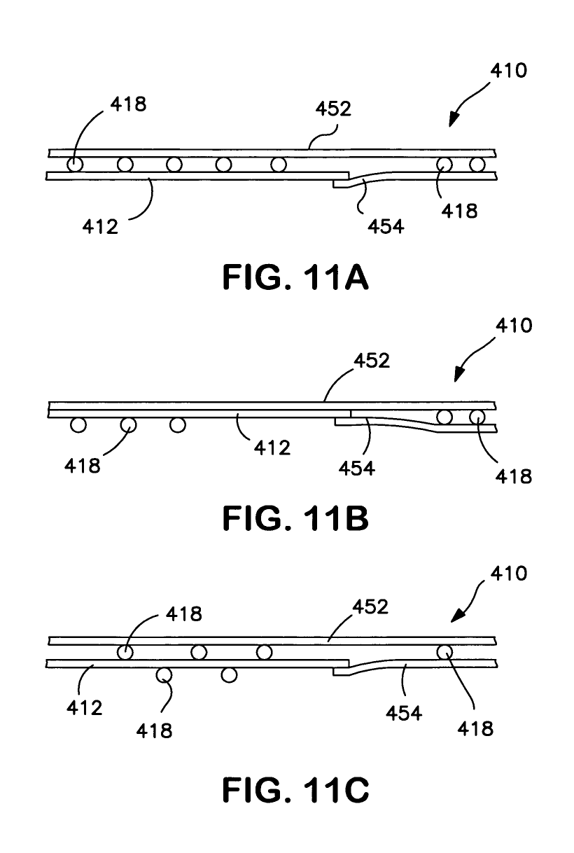

FIGS. 11A, 11B, and 11C illustrate targeted elastic laminate materials 410 similar to the materials shown in FIGS. 9A, 9B, 9C, and 9D, but with the second facing layer 454 having a width narrower than the carrier layer 412 and extending only partially over the carrier layer 412.

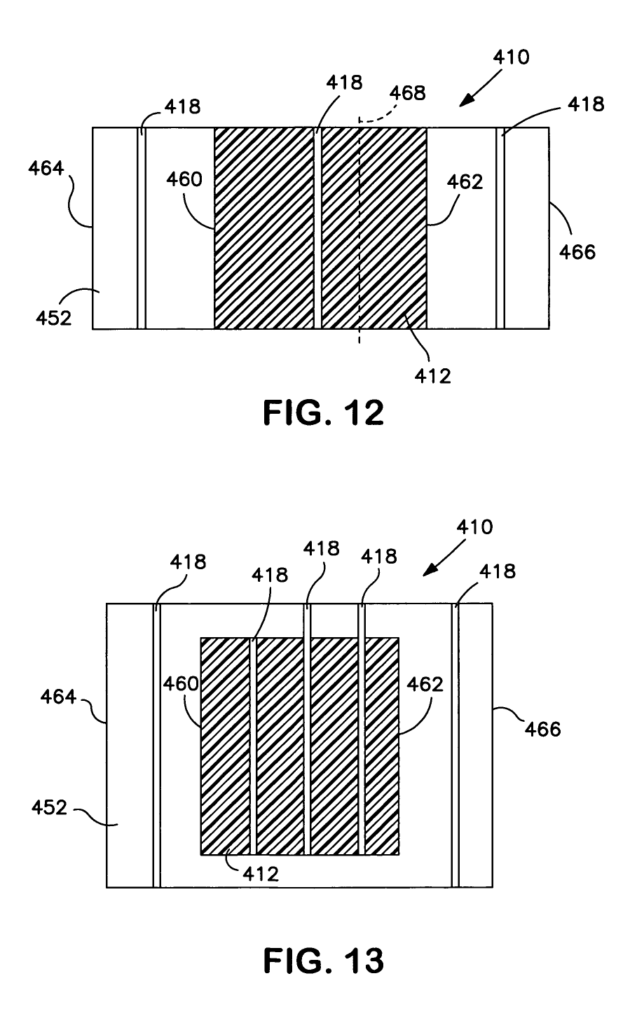

A top view of the targeted elastic laminate material 410 is shown in FIG. 12. As can be seen in FIG. 12, the elastomeric strands 418, the carrier layer 412, and/or the facing layers 452, 454 can be substantially the same length. The carrier layer 412 distributes the tension across the width of the targeted elastic laminate material 410, thus rendering the material conducive to cutting along the longitudinal length of the material. More particularly, the targeted elastic laminate material 410 can be cut into two or more individual targeted elastic laminate materials 410 along a longitudinal cut line 468. The carrier layer 412 provides reinforcement along the cut, which prevents any dangling of the elastomeric strands 418 resulting from the cut. The targeted elastic laminate material 410 may but need not be symmetrical across the longitudinal cut line 468. In another embodiment, shown in FIG. 13, the elastomeric strands 418, the carrier layer 412, and/or the facing layers 452, 454 may differ in length. Furthermore, in other embodiments (not shown) the elastomeric strands 418 may be partially attached to the carrier layer 412, such as when the elastomeric strands 418 and the carrier layer 412 differ in length, or when the carrier layer 412 has non-linear longitudinal edges 460, 462, or when either the carrier layer 412 and/or the elastomeric strands 418 are non-parallel to a machine direction of the targeted elastic laminate material 410.

As in the embodiments illustrated in FIGS. 4-6, the elastomeric strands 418 in the embodiments illustrated in FIGS. 9A-13 may also be spaced apart at varying intervals, exhibit different amounts of elastic tension, have different cross-sectional dimension, and/or have different compositions than one another. Additionally, or alternatively, portions of the carrier layer 412 may exhibit different amounts of elastic tension than one another. For example, the portions may be distinguished along the transverse axis, along the longitudinal axis, in a central region versus a peripheral region, or in any other suitable manner. More particularly, the film die may be tooled in a manner to vary the thickness of the film along a cross-direction of the film.

The carrier layer 412 may include the same elastomeric polymer material as the elastomeric strands 418. Alternatively, the carrier layer 412 may include a different polymer material than the elastomeric strands 418. For example, the carrier layer 412 may be an elastomeric film, a sheet of netting, a nonwoven material or laminate, or a combination of any of these materials.

Materials suitable for use in preparing carrier layers, such as elastomeric films and netting, and strands include diblock, triblock, tetrablock or other multi-block elastomeric copolymers such as olefinic copolymers, including styrene-isoprene-styrene, styrene-butadiene-styrene, styrene-ethylene/ butylene-styrene, or styrene-ethylene/propylene-styrene, which may be obtained from a variety of manufacturers including Kraton Polymers, under the trade designation KRATON® elastomeric resin, as well as from Dynasol in Spain, Dexco in Houston, Tex., and Kuraray (Septon Company of America) in Houston, Tex.; polyurethanes, including those available from E. I. Du Pont de Nemours Co., under the trade name LYCRA®; polyamides, including polyether block amides available from Ato Chemical Company, under the trade name PEBAX® polyether block amide; polyesters, such as those available from E. I. Du Pont de Nemours Co., under the trade name HYTREL® polyester; and single-site or metallocene-catalyzed polyolefins having density less than about 0.89 grams/cc, available from Dow Chemical Co. under the trade name AFFINITY®. Still other acceptable materials are available from Exxon-Mobil under the trade names EXACT® and VISTAMAXX®, and from Dow Chemical Co. under the trade name VERSIFY®.

A number of block copolymers can also be used to prepare elastomeric strands and films useful in this invention. Such block copolymers generally comprise an elastomeric midblock portion B and a thermoplastic endblock portion A. The block copolymers may also be thermoplastic in the sense that they can be melted or softened, formed, and resolidified several times with little or no change in physical properties (assuming a minimum of oxidative degradation). Alternatively, the elastomeric strands 418 and/or films 412 can be made of a polymer that is not thermally processable, such as LYCRA® spandex, available from E. I. Du Pont de Nemours Co., or cross-linked natural rubber in film or fiber form. Thermoset polymers, unlike the thermoplastic polymers, once cross-linked cannot be thermally processed, but can be obtained on a spool or other form and can be stretched and applied to the film or strands in the same manner as thermoplastic polymers. As another alternative, the elastomeric strands and/or films (such as those made of AFFMNITY®, available from Dow Chemical Co.) can be converted into a thermoset polymer that can first be processed like a thermoplastic prior to conversion, i.e. stretched and applied, and then treated with radiation, such as electron beam radiation, gamma radiation, or UV radiation to cross-link the polymer, or use polymers that have functionality built into them such that they can be moisture-cured to cross-link the polymer, thus resulting in a polymer with the enhanced mechanical properties of a thermoset.

Suitable block copolymers usefuil in this invention include at least two substantially polystyrene endblock portions and at least one substantially ethylene/butylene mid-block portion, for example an A-B-A block copolymer. A commercially available example of such a linear block copolymer is available from Kraton Polymers under the trade designation KRATON® G1657 elastomeric resin. Another suitable elastomer is KRATON® G2740 formulation, which is based on KRATON® G1657 with a wax and tackifier.

Endblock portion A may comprise a poly(vinylarene), such as polystyrene. Midblock portion B may comprise a substantially amorphous polyolefin such as polyisoprene, ethylene/propylene polymers, ethylene/butylene polymers, polybutadiene, and the like, or mixtures thereof.

Elastic elements of the present invention may also contain blends of elastic and inelastic polymers, or of two or more elastic polymers, provided that the blend exhibits elastic properties. A tackifier or any suitable pressure-sensitive adhesive may also be included in the formulation of the film or strands. The strands are substantially continuous in length. The elastic strands may be circular but as previously mentioned, may also have other cross-sectional geometries such as elliptical, rectangular, triangular or multi-lobal. In one embodiment, one or more of the filaments may be in the form of elongated, rectangular strips produced from a film extrusion die having a plurality of slotted openings.

The facing layer or layers 452, 454 may each include a nonwoven web, for example a spunbonded web or a meltblown web, a woven web, or a film. In certain embodiments, the facing materials may be stretchable and/or elastomeric. Facing materials may be formed using conventional processes, including the spunbond and meltblowing processes described in the “DEFINITIONS.” For example, facing materials 452, 454 may include a spunbonded web having a basis weight of about 0.1-4.0 osy, suitably 0.2-2.0 osy, desirably about 0.4-0.6 osy. The facing materials may include the same or similar materials or different materials.

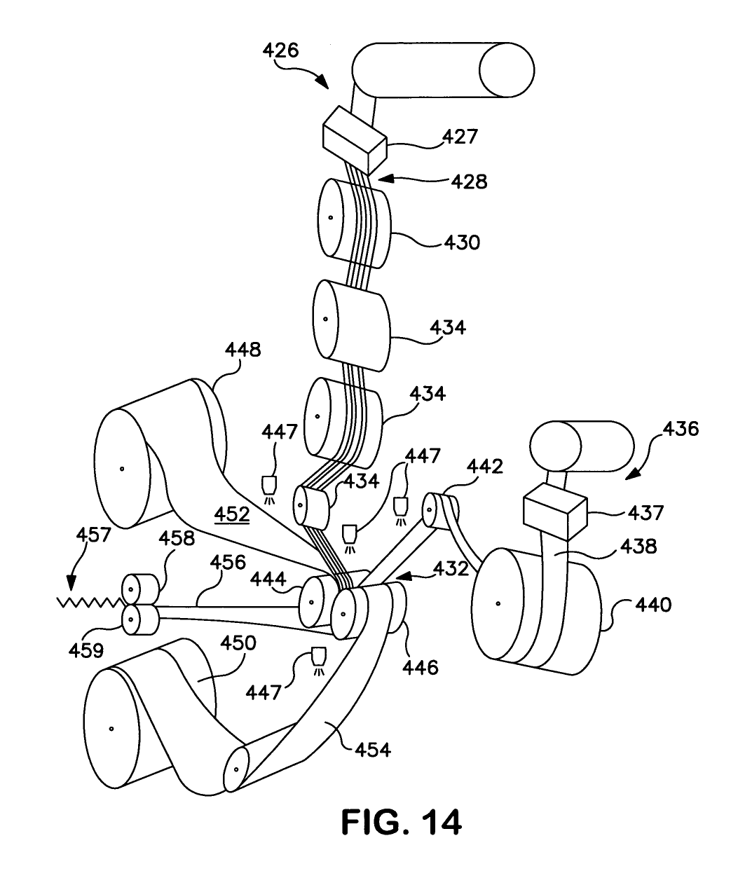

FIG. 14 illustrates a method and apparatus for making any of the targeted elastic laminate materials according to FIGS. 4-7 and 9-12. The double-filmed laminate of FIG. 8 would of course have another line added for forming the second film. While FIG. 14 illustrates a composite vertical filament stretch-bonded lamination (VF SBL) process it will be appreciated that other processes consistent with the present invention may be utilized. A first extruder 426 produces strands of elastic material 428 through a filament die 427. The strands 428 are fed to a first chill roller 430 and stretched conveyed vertically towards a nip 432 by one or more first fly rollers, collectively 434, in the strand-producing line.

A second extruder 436 using a slotted film die 437 produces a film of elastic material 438, of, for example, about 7.5 inches in width and ten (10) mils thickness, which is fed onto a second chill roller 440 and conveyed to one or more second fly rollers, collectively 442, towards the nip 432. The film 438 may be stretched down to about two inches width and thinned to about 2 mils by the second fly rollers 442 during its passage to the nip 432. The nip 432 is formed by opposing first and second nip rollers 444 and 446, respectively. Since the film 438 and the strands 428 are extruded and formed separately prior to reaching the nip 432, the film 438 and the strands 428 may be stretched by different amounts, or by the same amount, to achieve the preferred tension and elongation in the individual components prior to forming the laminate. The elastic laminate 410 (FIG. 4) is formed by securing at least one of the strands 428 to the film 438 and securing at least another one of the strands to a first facing layer 452 adjacent to the carrier layer 438 in the nip 432 by heat, pressure, adhesives or combinations thereof. Adhesive sprayers, collectively 447, may be placed as desired on each material's path before entry into the nip.

Suitable materials for the film 438 and the strands 428 are described in detail above. Any of the thermoset polymers described above may be included in the formation of the film 438 and/or the strands 428, and may be cross-linked prior to securing the strands 428 to the film 438. Alternatively, the film 438 and/or the strands 428 may be formed of any suitable polymer material that may be cross-linked after securing the strands 428 to the film 438.

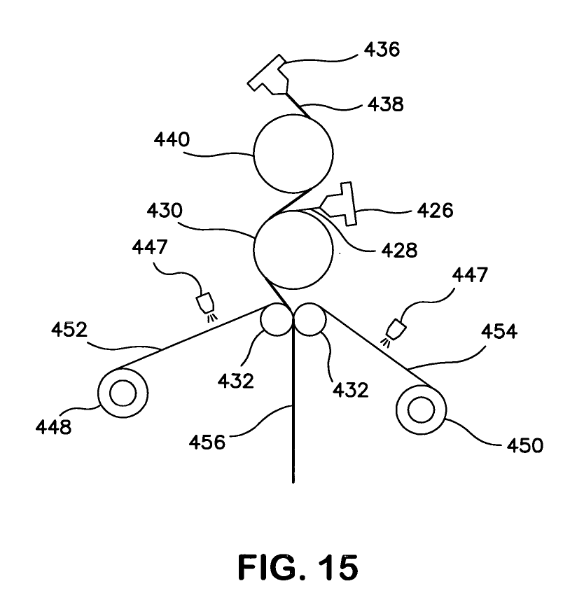

FIG. 15 illustrates a VF SBL process in which no fly rollers 434 are used. Instead, the film 438 is extruded onto chill roller 440. The strands 428 are extruded onto chill roller 430, where the strands 428 and the film 438 converge. The strands 428 and the film 438 are stretched between the chill rollers 430, 440 and the nip 432. Except for the lack of fly rollers 434, the processes of FIGS. 14 and 15 are similar. In either case, the strands 428 and the film 438 together are laminated between a first facing layer 452 and a second facing layer 454 (optional) at the nip 432.

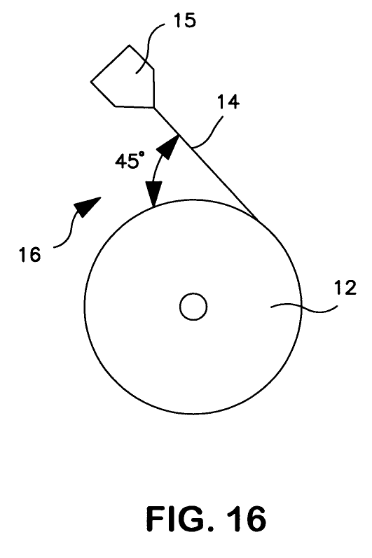

FIG. 16 illustrates a side view of an extruder 15 in a canted position relative to the vertical axis of a roller 12. The 45° angle indicated on the Figure has been found to be one angle that produces an acceptable product and that allows the continuous filaments to mate with roller 12, although other suitable angles are possible depending on the configuration of the machine.

The die of each extruder 15 may be positioned with respect to the first roller 12 so that the continuous filaments 14 meet this first roller 12 at a predetermined angle 16. This strand extrusion geometry is particularly advantageous for depositing a melt extrudate onto a rotating roll or drum. An angled, or canted, orientation provides an opportunity for the filaments to emerge from the die at a right angle to the roll tangent point resulting in improved spinning, more efficient energy transfer, and generally longer die life. This improved configuration allows the filaments to emerge at an angle from the die and follow a relatively straight path to contact the tangent point on the roll surface. The angle 16 between the die exit of the extruder and the vertical axis (or the horizontal axis of the first roller, depending on which angle is measured) may be as little as a few degrees or as much as 90°. For example, a 90° extrudate exit to roller angle could be achieved by positioning the extruder directly above the downstream edge of the first roller and having a side exit die tip on the extruder. Moreover, angles such as about 20°, about 35°, or about 45° away from vertical may be utilized. It has been found that, when utilizing a 12-filament/inch spinplate hole density, an approximately 45° angle (shown in FIG. 16) allows the system to operate effectively. The optimum angle, however, will vary as a function of extrudate exit velocity, roller speed, vertical distance from the die to the roller, and horizontal distance from the die centerline to the top dead center of the roller. Optimal performance can be achieved by employing various geometries to result in improved spinning efficiency and reduced filament breakage. In many cases, this results in potentially increased roll wrap resulting in more efficient energy transfer and longer die life due to reduced drag and shear of the extrudate as it leaves the capillaries of the extruder die and proceeds to the chilled roll.

In order to form the targeted elastic laminate material 456, first and second rolls 448 and 450, respectively, of spunbond facing material, 452 and 454, are fed into the nip 432 on either side of the elastic strands 428 and film 438 as the elastic strands and film are stretched and bonded to the facing material accordingly. The spunbond facing material might also be made in situ rather than unrolled from previously-made rolls of material. While illustrated as having two lightweight gatherable spunbond facings, it will be appreciated that only one facing material, or various types of facing materials, may be used. The bonded targeted elastic laminate material 456 is maintained in stretched condition by a pair of tensioning rollers 458, 459 downstream of the nip and then relaxed as at Ref. No. 457.

The facing materials 452, 454 can be bonded to the elastic strands 428 and film 438 by using an adhesive, for example an elastomeric adhesive such as Findley H2525A, H2525 or H2096. Other bonding means well known to those having ordinary skill in the art may also be used to bond the facing materials 452, 454 to the elastic laminate 410, including thermal bonding, ultrasonic bonding, mechanical stitching, and the like.

Several patents describe various spray apparatuses and methods that may be utilized in supplying the meltspray adhesive to the outer facing(s) or, when desired, to the elastic laminate. For example, the following United States patents assigned to Illinois Tool Works, Inc. (“ITW”) are directed to various means of spraying or meltblowing fiberized hot melt adhesive onto a substrate: U.S. Pat. Nos. 5,882,573; 5,902,540; 5,904,298. These patents are incorporated herein in their entireties by reference thereto in a manner consistent with this invention. The types of adhesive spray equipment disclosed in the aforementioned patents are generally efficient in applying the adhesive onto the nonwoven outer facings in the VFL process of this invention. In particular, ITW-brand Dynatec spray equipment, which is capable of applying about 3 gsm of adhesive at a run rate of about 1100 fpm, may be used in the melt-spray adhesive applications contemplated by the present inventive process. Other suitable adhesive application techniques include kiss-coating, which involves locating the film die very close to the facing materials, as well as porous-coating, which can be carried out using equipment available from Nordson Co.

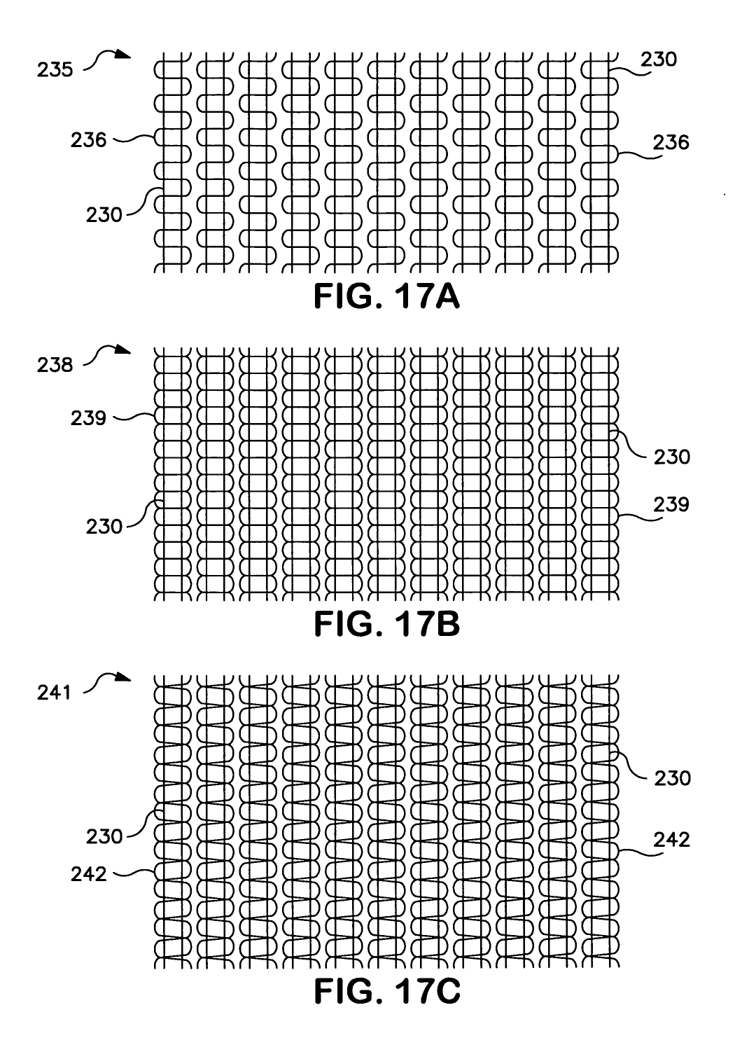

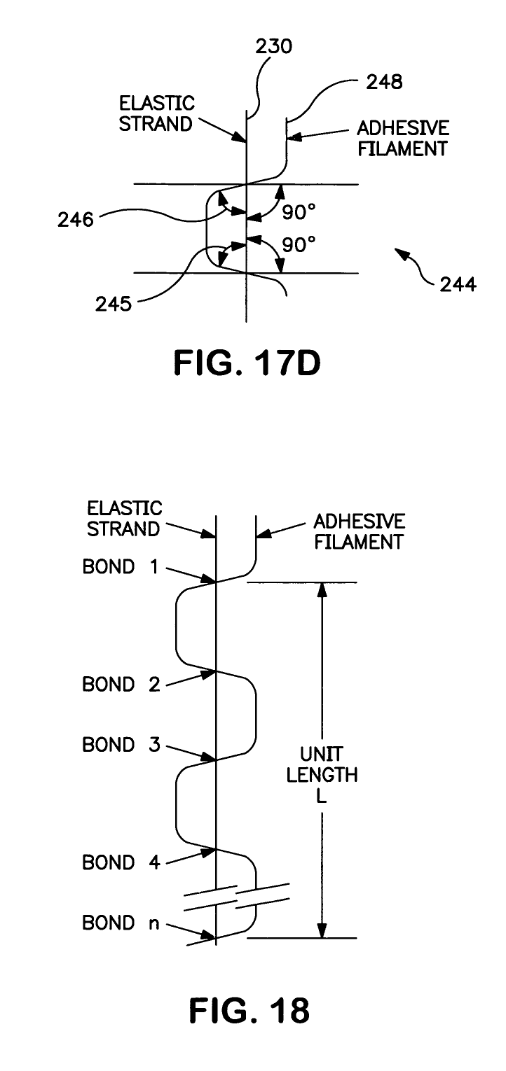

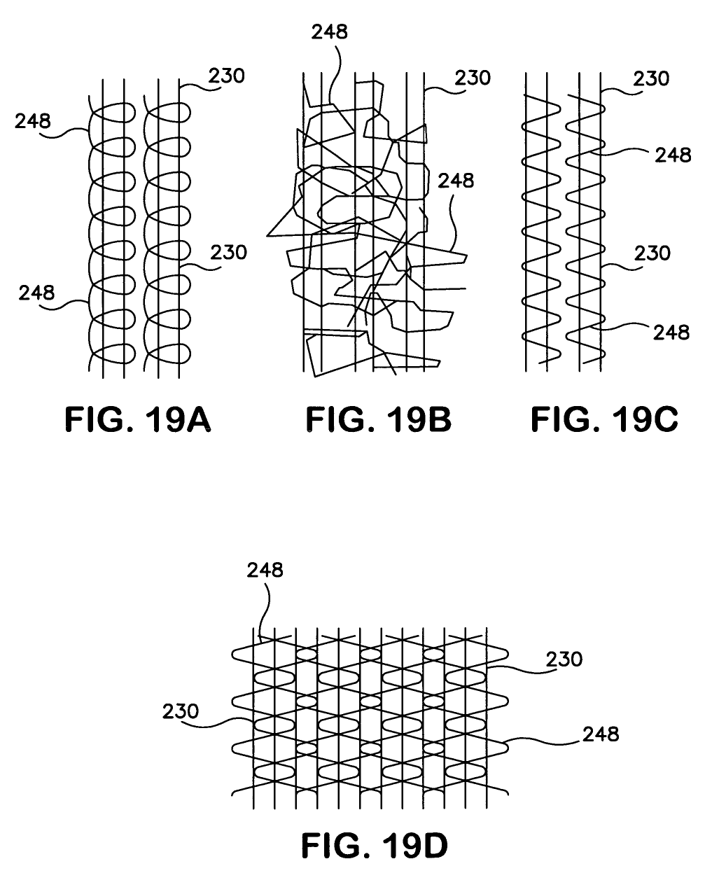

Several representative adhesive patterns are illustrated in FIGS. 17A through 19D. Applying an adhesive in a cross-machine pattern such as the ones shown. in FIGS. 19C and 19D may result in certain adherence advantages. For example, because the elastic laminate is generally placed in the machine direction, or direction of processing, having the adhesive pattern orient to a large degree in the cross-machine direction provides multiple adhesives to elastic crossings per unit length. For this discussion, the elastic strands of the laminate of the present invention will be used for ease of illustration. It will be noted that the strands are oriented on the film of the laminate in the machine direction.

In addition, in many particular embodiments of the present invention, the adhesive component is applied to the surface of the nonwoven facing sheet, or layer, in discrete adhesive lines. The adhesive may be applied in various patterns so that the adhesive lines intersect the elastic filament lines to form various types of bonding networks which could include either adhesive-to-elastic bonds or adhesive-to-elastic bonds, adhesive-to-facing layer, and adhesive-to-adhesive bonds. These bonding networks may include a relatively large total number of adhesive-to-elastic and adhesive-to-adhesive bonds that provide the laminated article with increased strength, while utilizing minimal amounts of adhesive. Such enhancements are achieved by the use of adhesive sprayed onto the surface of the nonwoven in a predetermined and specific pattern. In most cases, a final product with less adhesive exhibits a reduction in undesirable stiffness, and is generally more flexible and soft than products having more adhesive.

Applying the adhesive in a pattern so that the adhesive lines are perpendicular or nearly perpendicular to the machine direction of the elastic components has been found particularly advantageous. A true 90° bond angle may not be possible in practice, but an average or mean bond angle that is as great as 50° or 60° will generally produce a suitable bond between the elastic laminate and the facing material. A conceptual illustration of these types of bond angles is shown in FIGS. 17D and 18. The adhesive-to-elastic bonds are formed where the lines of adhesive 248 and elastic strands 230 join or intersect.

The continuous adhesive filaments-to-elastic strand intersections are also controlled to a predetermined number of intersections per unit of elastic laminate length. By having such adhesive lines in a perpendicular orientation and optimizing the number of bonds per unit of elastic laminate length, the final bonded material, or targeted elastic laminate material, can be produced with a minimal amount of adhesive and elastomeric material to provide desirable product characteristics at a lower cost.

If the adhesive-to-elastic bonds are too few in number or are too weak, then the elastic tension properties of the targeted elastic laminate material may be compromised and the tension applied to the elastic may break the adhesive joints. In various known processes, the common remedy for this condition is to increase the number of bonding sites by either increasing the meltspray air pressure, or by slowing the bonding, or lamination, speed. As the meltspray air pressure is increased, the resulting adhesive fiber size is reduced, creating weaker bonds. Increasing the amount of adhesive used per unit area to create larger adhesive filaments can strengthen these weaker bonds, which usually increases the cost of the laminate. Lowering the lamination speed decreases machine productivity, negatively impacting product cost. The present invention, in part, may utilize an effective bonding pattern where the number of bond sites per length of elastic are prescribed and where the adhesive-to-elastic strand joints are generally perpendicular in orientation in order to provide maximum adhesive strength. This allows the targeted elastic laminate material to be made at minimal cost by optimizing the adhesive and elastomer content to match the product needs.

FIG. 17A shows one exemplary scrim pattern useful in the present invention in which the adhesive has been applied to the elastic filaments with attenuation of the adhesive lines in the cross-machine direction. Scrim pattern 235 includes adhesive line 236 and elastic filaments 230. FIG. 17B illustrates another exemplary scrim pattern 238 having adhesive lines 239 applied to elastic strands 230. In this embodiment, it can be seen that the bond angle is very high, approaching 90° at the intersection between the adhesive and the elastic filaments. FIG. 17C illustrates still another scrim pattern 241 having adhesive lines 242 and continuous elastic strands 230.

As used herein, a “scrim” refers generally to a fabric or nonwoven web of material which may be elastic or inelastic, and having a generally machine direction (“MD”) oriented strand component along the path of product flow during manufacture and a generally cross-machine direction (“CD”) strand component across the width of the fabric.

As previously discussed, FIG. 17D illustrates the relatively high bond angle that may be employed in products produced according to the present invention. In particular, lay down angle 244 is shown as the angle formed by the adhesive line 248 and the elastic strand 230. Adhesive/elastic angle 246 and adhesive/elastic angle 245 are shown as being less than 90°.

FIG. 18 utilizes an exemplary bonding pattern to conceptually illustrate the measurement for determining the number of bonds per unit length on elastic strands or filaments. FIG. 19A shows another exemplary bonding pattern having the adhesive-to-adhesive bonding wherein a swirled type of configuration is employed. FIG. 19B illustrates a more randomized pattern wherein a large percentage of adhesive lines are in a perpendicular, or almost perpendicular, orientation to the elastic filaments. FIG. 19C is another exemplary embodiment of a bonding pattern having no adhesive-to-adhesive bonds, but numerous adhesive-to-elastic strand bonds. FIG. 19D illustrates another exemplary bonding pattern that has both adhesive-to-adhesive and adhesive-to-elastic strand bonds. The configuration shown in FIG. 19D is similar to the design of a chain-link fence.

### EXAMPLE 1

In an assembly known as the Vertical Filament Laminator (VFL), strands of an elastomeric polymer made up of 65.5% KRATON® G1730, 12% of a low molecular weight polyethylene wax, NA 601 available from U.S.I. Chemical Company, and 22.5% of a pressure sensitive adhesive such as Regalrezm of Hercules Inc., of Wilmington, Del., were extruded onto the top of a chill roll. The elastic strands were subsequently stretched successively through a series of rolls stacked in a vertical fashion, one on top of each other, under the chill roll and into a pair of nip rolls, i.e. rolls creating a nip. In the nip, the facing sheets and tackified stretched elastic strands meet whereupon the strands are bonded to the facings, under pressure, to form a laminate that, when it exits the nip, is allowed to relax to varying degrees for gathering. Alternatively, an external hot melt adhesive can be sprayed on the facing sheets, prior to entering the nip, in order to bond a non-tackified elastomer to the facing sheets.

In the VFL assembly, a film of the same elastomer was cast from a second extruder using a slotted film die at a width of 7.5 inches and approximately 10 mil thick adjacent to the strands. Because of the close proximity of the strands and film they make contact with each other. at the initial cooling roller. The film width, initially at 7.5 inches, narrowed to 2 inches when passed over all the rolls, which were run at differential speed together with the strands. The film also thinned down to approximately 2 mils thickness in the final gathered laminate after passing through the nip. A difficulty was perceived in introducing the film and strands on top of the same chill roll together.

A second approach was adopted for the successful development of the film based banded or targeted elastic laminate by casting the film onto a separate chill roll using the slotted film die. The film was guided to the nip through one or more fly rolls and laminated together with the strands between the facings. In this construction, no attempt was made to separate the strands from the area in which film was present, the strand was laid just on top of the film. In other words, the strand lay down had no discontinuity. The stretch of the film and strands from their extruders had to be identical to produce a laminate with uniform gathering. To achieve a differential gathering of the elastic targeted zones, a differential stretch prior to bonding is recommended. The initial width and gap of the film die was adjusted to effect the width and thickness of the film in the final laminate. Alternatively, the forming distance (distance between the die and the chill roll), chill roll speed and polymer throughput can also be adjusted to change the dimensions of the film. It was observed during the processing that an increase in stretch of the elastomer to achieve a higher stretch-to-stop (STS) of 230-260%, when compared with a control material of 80-190% STS, results in delamination of the strands from the film. Use of excess adhesive in the elastomeric materials also results in reduction of stretch to stop of the laminate. Hence I gsm of a Findley 2096 adhesive was melt sprayed on the facing in addition to the tackifier present in the elastomer formulation which resulted in excellent adhesion and provided 230%+ elongation. Another observation made during the production of the elastic laminate was that the film chill roll temperature had to be around 25° C. to prevent the film from breaking. Of course, different formulations of laminate components may require different temperature controls.

### EXAMPLE 2

In this example, targeted elastic materials were tested in terms of load elongation, a 3-cycle hysteresis test, and stress relaxation at body temperature. In the load elongation test, the samples included a targeted elastic sample of film made up of 65.5% KRATON® G1730, 12% of a low molecular weight polyethylene wax, NA 601, and 22.5% of a pressure sensitive adhesive such as Regalrez™, together with filament made up of 85% KRATON® G1730 and 15% wax, a filament-based non-targeted-elastic sample of 80% KRATON® G1730, 13% tackifier, and 7% wax, and a control of filament-based non-targeted-elastic sample of KRATON® 2760, which is the commercial side panel material used in PULL-UPS® Disposable Training Pants. In the hysteresis test, the samples included a targeted elastic sample of film made up of 65.5% KRATON® G1730, 12% of a low molecular weight polyethylene wax, NA 601, and 22.5% of a pressure sensitive adhesive such as Regalrez™, together with filament made up of 85% KRATON® G1730 and 15% wax, and a filament-based non-targeted-elastic sample made up of 80% KRATON® G1730, 13% tackifier, and 7% wax. The control sample was the side panel material used in the PULL-UPS® Disposable Training Pant, based on KRATON® G 2760 polymer. In the stress relaxation test, the samples tested included targeted elastic material made up of a film including 65.5% KRATON® G1730, 12% of a low molecular weight polyethylene wax, NA 601, and 22.5% of a pressure sensitive adhesive such as Regalrez™, and filaments including 80% KRATON® G1730, 13% tackifier, and 7% wax, with the filaments overlaid on the film. Non-targeted-elastic portions of a laminate were based solely on the filaments made up of 80% KRATON® G1730, 13% tackifier, and 7% wax. The control sample used in the stress relaxation test was a laminate based on LYCRA® spandex, available from E. I. Du Pont de Nemours Co., in a non-targeted-elastic type laminate material construction.

Load Elongation

The load-elongation behavior of the laminates was obtained at room temperature using a Sintech 1/S testing frames. Rectangular laminate samples having 3-inch widths were clamped at a grip-to-grip distance of 4 inches and were pulled at a cross-head displacement of 20 inches/minute. Samples were stretched to approximately 2000 grams load limit. The elongation was calculated from knowledge of the change in length and the original length of the sample. The tension at 50% elongation was calculated from the data acquired.

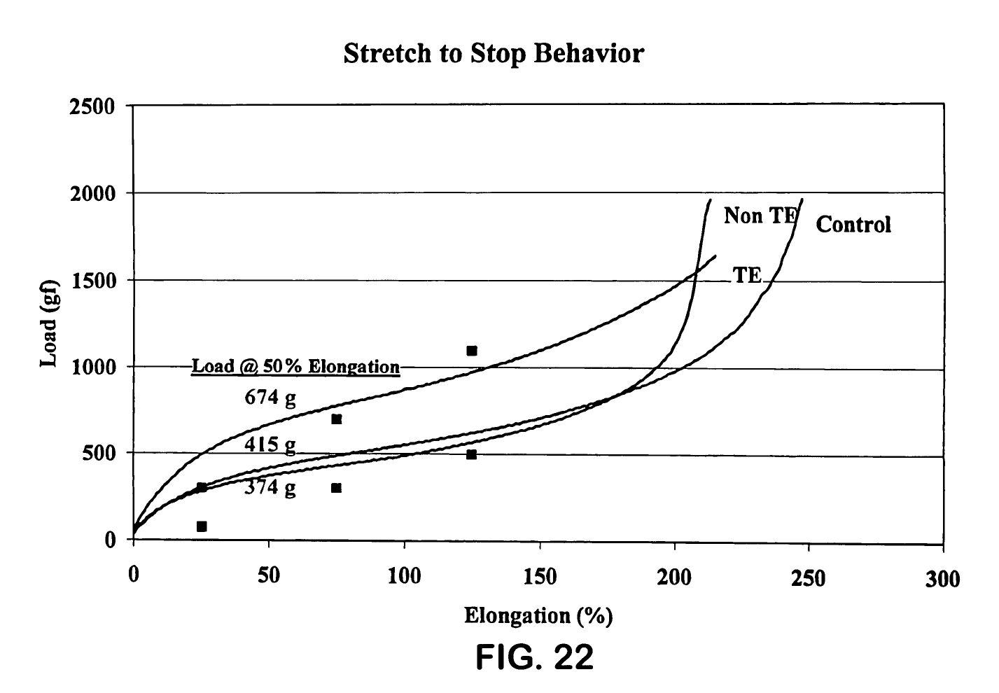

FIG. 22 shows the load elongation curves for the targeted elastic, non-targeted-elastic and control laminate samples. The targeted elastic portion was a 2-inch wide film made up of 65.5% KRATON® G1730, 12% of a low molecular weight polyethylene wax, NA 601, and 22.5% of a pressure sensitive adhesive such as Regalrez™, on top of strands of 85% KRATON® G1730 and 15% wax, of less than 0.03 inch diameter at 12 strands per inch. The number of strands per inch and the thickness of the targeted elastic film can be changed independently or in combination, to alter the load-elongation characteristics of the elastic laminate material. The 3-inch samples tested had 1 to 2.5-inch wide film and elastic strand overlaid on it. The additional 0.5 to 2 inches of material consisted of the non-targeted-elastic portion. In other words, targeted elastic samples tested had a width of 3 inches consisting of both targeted elastic and non-targeted-elastic portions. The targeted elastic and non-targeted-elastic portions could also be tested separately to define the material specifications. It can be seen from FIG. 22 that the tension as a function of elongation is lower (up to about 150%) for the non-targeted-elastic portions and higher for the targeted elastic portions. The targeted elastic panel also provides an additional advantage. Having a higher tension as a function of elongation of the side panel material means that when the targeted elastic panel stress decays as a function of time at body temperature, it will still be at a higher tension than the control and non-targeted-elastic material after a given period of time. For example, consider the targeted elastic material, which has 674 grams at 50% elongation. Examination of Table 1 shows that this material stress relaxes 50% in 12 hours at body temperature. This implies that after 12 hours the material will be at a load of 324 grams. Compare this value with the control, which is at 415 grams at 50% elongation and it stress relaxes 50% after 12 hours. Fifty percent of 415 is 208 grams. Thus the targeted elastic material is at 116 grams higher than the control at the end of 12 hours which delivers better tension to the body and therefore better body fit over time.

3-Cycle Hysteresis Test

Equilibrium hysteresis behavior of the polymers was obtained by ramping a rectangular specimen up to 160% and down to 0% elongation at 20 inches/minute at room temperature. The procedure was repeated 3 times. Most of the samples attained equilibrium in 2 to 3 up-and-down ramping cycles.

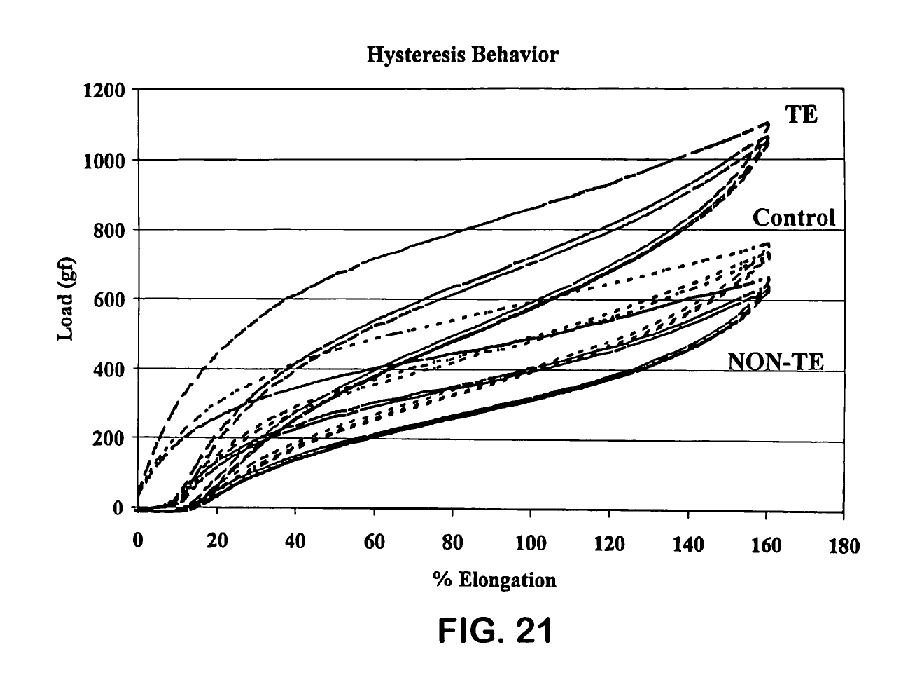

The three curves shown in FIG. 21 are for the targeted high-tension targeted elastic laminate material, the control (PULL-UPS® Disposable Training Pants with uniform tension), and the low tension targeted elastic laminates. The curves also serve the purpose of illustrating the donning process to which a product might be subjected before putting the product on the user. It can be seen from the figure that each material loses some of its tension on the second and third loading in comparison with the first loading cycle. However, the tension remains relatively constant for all three unloading cycles. The second and third loading cycles have similar loading tensions as a function of elongation. It can also be seen that in all cases some of the lost load on unloading is restored on the loading cycles. The figure illustrates that the tension of the control is in between the targeted and non-targeted elastic materials.

Stress Relaxation at Body Temperature

Stress relaxation of the elastomer at body temperature is used mainly for rating the dimensional stability of the material. Stress relaxation is defined as the force required to hold a given elongation constant over a period of time. Hence, it is a transient response which mimics personal care products in use. In this experiment, the load loss (stress relaxation) as a function of time was measured at body temperature. The rate of change of the property as a function of time was obtained by calculating the slope of a log-log regression of the load and time. In addition to the rate of loss as a function of time, the percentage of load loss was calculated from the knowledge of the initial and final loads. The duration of the experiment was matched with the time a product stays on the body in real use. A perfectly elastic material, such as a metal spring, for instance, is expected to give a value of zero for both slope and load loss.

In the stress relaxation characterization, a 3-inch width of the laminate specimen was used for the test. Samples were tested in a Sintech mechanical test frame in an environmental chamber at 100° F. (38° C.). An initial 3-inch grip-to-grip distance was displaced to a final 4.5 inches (50% elongation) at a cross-head displacement speed of 20 inches/minute. The load loss as a function of time was then acquired over a period of 12 hours using the Testworks data acquisition capability of the MTS Sintech test equipment.

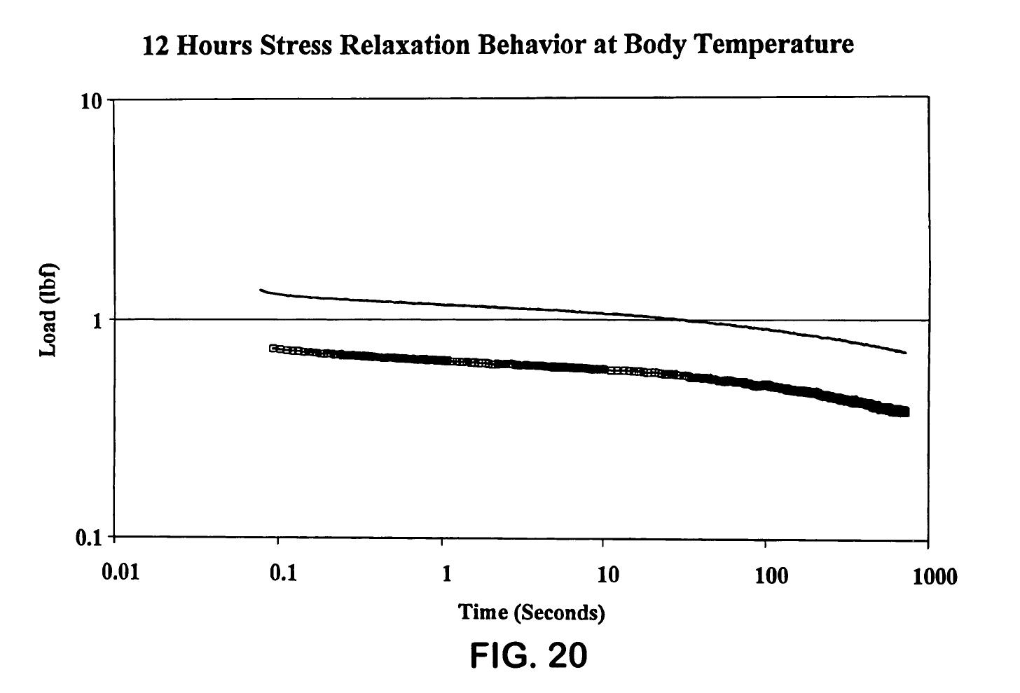

FIG. 20 shows the stress relaxation behavior of the targeted elastic (TE) and non-targeted-elastic (non-TE) portions of the laminate. Table 1, below, shows the load decay rates and load loss at the end of 12 hours for the targeted elastic and non-targeted-elastic materials. LYCRA® spandex was included as a control.

TABLE 1

| Laminate | Load Decay Rate | % Load Loss (12 hr) |
|---|---|---|
| Control (CFSBL) | −0.08 | 50 |
| TE Zone | −0.07 | 48 |
| Non-TE Zone | −0.08 | 49 |
| LYCRA ® spandex | −0.02 | 10 |

The invention further encompasses various types of garments in which a high tension and/or low stretch gasketing elastic zone is present in the vicinity of any one or more garment openings. Depending on the garment, high tension and/or low stretch gasketing zones of a targeted elastic laminate material may encircle an entire garment opening or just a portion of the garment opening. In addition to the training pant 20, other types of garments on which this invention can be used include personal care garments, such as diapers, absorbent underpants, adult incontinence products, certain feminine hygiene articles, and swim wear. The high tension and/or low stretch gasketing elastic zones may be used in similar fashion in medical garments including, for instance, medical gowns, caps, gloves, drapes, face masks, and the like, where it is desired to provide a gasket in the vicinity of one or more garment openings without requiring a separately manufactured and attached elastic band. Furthermore, the high tension and/or low stretch gasketing elastic zone can be used around neck openings, arm openings, wrist openings, waist openings, leg openings, ankle openings, and any other opening surrounding a body part wherein fluid transfer resistance is desirable.

While the embodiments of the invention described herein are presently preferred, various modifications and improvements can be made without departing from the spirit and scope of the invention. The scope of the invention is indicated in the appended claims, and all changes that fall within the meaning and range of equivalents are intended to be embraced therein.

1. A targeted elastic laminate material, comprising:
a plurality of elastomeric strands attached to a first facing layer; and
a carrier layer having a width narrower than a width of the first facing layer and attached to the first facing layer, wherein at least a first one of the elastomeric strands is directly attached to the first facing layer adjacent to the carrier layer.

2. The targeted elastic laminate material of claim 1, wherein at least some of the elastomeric strands exhibit different amounts of elastic tension than one another.

3. The targeted elastic laminate material of claim 1, wherein at least some of the elastomeric strands have different cross-sectional dimensions than one another.

4. The targeted elastic laminate material of claim 1, wherein at least some of the elastomeric strands have different compositions than one another.

5. The targeted elastic laminate material of claim 1, wherein different portions of the carrier layer exhibit different amounts of elastic tension than one another.

6. The targeted elastic laminate material of claim 1, wherein at least a second one of the elastomeric strands is directly attached to the carrier layer.

7. The targeted elastic laminate material of claim 6, wherein at least a third one of the elastomeric strands is directly attached to the carrier layer on a surface opposite the second one of the elastomeric strands.

8. The targeted elastic laminate material of claim 1, wherein the first facing layer comprises at least one of the group consisting of a nonwoven web, a spunbond web, a meltblown web, a woven web, a film, and combinations thereof.

9. The targeted elastic laminate material of claim 1, wherein the carrier layer comprises an elastomeric film.

10. The targeted elastic laminate material of claim 1, wherein the carrier layer comprises the same polymer material as the plurality of elastomeric strands.

11. The targeted elastic laminate material of claim 1, wherein the carrier layer comprises a different polymer material than the plurality of elastomeric strands.

12. The targeted elastic laminate material of claim 1, wherein the elastomeric strands and the carrier layer are substantially the same length.

13. The targeted elastic laminate material of claim 1, further comprising a second facing layer attached to the first facing layer with at least a portion of the carrier layer positioned between the first and second facing layers, and at least the first one of the elastomeric strands positioned between and directly attached to the first and second facing layers.

14. A garment comprising the targeted elastic laminate material of claim 1 incorporated into the structure of the garment.

15. The garment of claim 14, wherein at least a portion of a waistband of the garment comprises the targeted elastic laminate material.

16. A targeted elastic laminate material, comprising:
a plurality of elastomeric strands attached to a first facing layer having a first longitudinal edge and a second longitudinal edge defining a width of the first facing layer;
a carrier layer attached to the first facing layer and having a first longitudinal edge and a second longitudinal edge defining a width of the carrier layer, the carrier layer having a narrower width than the width of the first facing layer;
at least a first one of the elastomeric strands directly attached to the first facing layer between the first longitudinal edge of the first facing layer and the first longitudinal edge of the carrier layer; and
at least a second one of the elastomeric strands directly attached to the first facing layer between the second longitudinal edge of the first facing layer and the second longitudinal edge of the carrier layer.

17. The targeted elastic laminate material of claim 16, wherein at least a third one of the elastomeric strands is directly attached to the carrier layer.

18. The targeted elastic laminate material of claim 16, further comprising a second facing layer attached to the first facing layer with at least a portion of the carrier layer positioned between the first and second facing layers, and at least the first and second ones of the elastomeric strands positioned between and directly attached to the first and second facing layers.

19. A method of producing a targeted elastic laminate material, comprising:
extruding at least one elastomeric first filament onto a surface adjacent to a carrier layer; and
attaching the at least one elastomeric first filament to a first facing layer.

20. The method of claim 19, fuirther comprising extruding at least one elastomeric second filament onto the surface adjacent to the carrier layer opposite the at least one elastomeric first filament.

21. The method of claim 20, further comprising extruding at least one elastomeric third filament onto the carrier layer.

22. The method of claim 19, further comprising placing elastomeric material extruded from a slotted film die onto a cooling roll and stretching the elastomeric film from the cooling roll towards a nip formed between two nip rollers to form the carrier layer.

23. The method of claim 22, further comprising adding a tackifier to a formulation of the film.

24. The method of claim 19, further comprising spraying at least one of the first facing layer, the carrier layer, and the at least one elastomeric first filament with an adhesive before securing the carrier layer and the at least one elastomeric first filament to the first facing layer.

25. The method of claim 19, wherein at least one of the carrier layer and the at least one elastomeric first filament comprises a thermoset polymer that is cross-linked prior to securing the at least one first filament to the carrier layer.

26. The method of claim 19, wherein at least one of the carrier layer and the at least one elastomeric first filament can be cross-linked after securing the at least one elastomeric first filament to the carrier layer.

27. The method of claim 19, further comprising attaching the carrier layer and the at least one elastomeric first filaments to a second facing layer.

28. The method of claim 27, wherein the surface adjacent to the carrier layer comprises the second facing layer.
